(19) United States
(12) Patent Application Publication
(10) Pub. No.: US 2004/0048596 A1
(43) Pub. Date: Mar. 11, 2004

(54) Method and apparatus for extending high bandwidth communication services to the edge of the network

(75) Inventors: Aneta Wyrzykowska, Kanata (CA); Martin Ridgeway Handforth, Kanata (CA)

Correspondence Address: JOHN C. GORECKI, ESQ., 165 HARVARD ST., NEWTON, MA, 02460, US

(73) Assignee: Nortel Networks Limited, St. laurent (CA)

(21) Appl. No.: 10/238,258

(22) Filed: Sep. 10, 2002

(51) Int. Cl. H04Q 7/20; H04M 11/00; H04B 7/00

(52) U.S. Cl. 455/403; 455/517

(57) ABSTRACT

High bandwidth services provided in the core of the network may be extended to the network edge by utilizing one or more underground wireless communications links. The underground communications link may be formed by burying a broadcasting antenna in a first underground location and then burying another underground antenna at a geographic point where services are desired. By transmitting the signals underground, it is possible to reach a large number of remote sites without undertaking the expense associated with providing direct high-speed fiber optic, cable, or wireline connections to those sites. Additionally, since the transmission is underground, the wireless communications may be provided in a portion of the spectrum otherwise licensed for use aboveground. This reuse of spectrum in a different transmission medium results in a large increase in the amount of data that may be transmitted over the existing allocated wireless spectrum.

### BACKGROUND OF THE INVENTION

1. Field of the Invention

The present invention relates to communication networks and, more particularly, to a method and apparatus for extending high bandwidth communications services to the edge of the network.

2. Description of the Related Art

Data communication networks may include various computers, servers, nodes, routers, switches, hubs, proxies, and other network devices coupled to and configured to pass data to one another. These various network elements will be referred to herein as “network devices.” Data is communicated through the data communication network by passing data packets (or data cells or segments) between the network devices by utilizing one or more communication links between the devices. A particular packet may be handled by multiple network devices and cross multiple communication links as it travels between its source and its destination over the network.

As data networks have grown in complexity and speed, the network devices used in those networks have likewise increased in complexity and speed. As higher bandwidth services are deployed in the core of the network, it has proved to be very expensive to extend the bandwidth advances all the way to the edge of the network. Specifically, in many geographic regions, the edge of the public switched telephone network (PSTN) was conventionally designed to accommodate very low bandwidth services. While this may be retrofitted in certain instances with relatively high-speed services, e.g. digital subscriber line (DSL), or integrated services digital network (ISDN), technical limitations prevent many areas of the PSTN from taking advantage of these technological advances. Thus, many regions of the network need to be rewired to take advantage of the increased bandwidth being deployed in the network core, which may be prohibitively expensive.

One way to extend high bandwidth communications services to the network edge is to use wireless communications links at the network edge. Atmospheric wireless communications links are cost effective, since a single network device may be used to reach many end users without requiring the replacement of wires between the network core and end users.

The development and deployment of wireless communications networks in many highly populated geographical regions is quickly reaching saturation, after which it will no longer be possible to add bandwidth to the network, absent an increase in available spectrum or an increase in transmission speed over the existing spectrum. Given the reticence of regulatory agencies to increase the available spectrum, the large expenses associated with acquiring licenses to the transmission spectrum, and the increasing demands being placed on networks due to advanced services sought to be deployed, atmospheric wireless networks are unlikely to be able to solve the problem of extending the high bandwidth core to the network edge.

Communications in many areas of the wireless spectrum must take place via line-of-sight transmissions. To enable an antenna to reach a large number of potential customers, towers of a great height are typically used to support wireless antennas. These large antennas are considered, in some communities, to be less than desirable additions to the skyline, and require a large piece of real estate to support the large base of the tall tower. Additionally, placing network equipment at the top of a tall tower increases the overall cost of the network equipment, since it must be made to be weather resistant and must meet certain electromagnetic radiation containment standards set forth by governmental regulations. These factors all contribute to increase the costs associated with purchasing, installing, maintaining, and operating atmospheric wireless networks.

### SUMMARY OF THE INVENTION

The present invention overcomes these and other drawbacks by providing a method and apparatus for extending the high bandwidth services provided in the core of the network to the network edge by utilizing one or more underground wireless communications links. The underground communications link may be formed by burying a broadcasting antenna in a first underground location and then burying another underground antenna at a geographic point where services are desired. For example, the first underground antenna may be buried at a central point and other antennas may be buried at houses where services are desired. By transmitting the signals underground, it is possible to reach a large number of remote sites without undertaking the expense associated with providing direct high-speed fiber optic, cable, or wireline connections to those sites. Additionally, since the transmission is underground, the wireless communications may be provided in a portion of the spectrum otherwise licensed for use aboveground. This reuse of spectrum in a different transmission medium results in a large increase in the amount of data that may be transmitted over the existing allocated wireless spectrum.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of a communications network according to an embodiment of the invention in which the base unit is above ground;

FIG. 2 is a functional block diagram of a communications network according to another embodiment of the invention in which the base unit is below ground;

FIG. 3 is a functional block diagram of a communications network according to another embodiment of the invention in which multiple base units communicate with each other as well as with remote units;

FIG. 4 is a functional block diagram of a communications network according to another embodiment of the invention in which underground wireless communications links are utilized to interconnect a base unit 10 with pico cells configured to transmit atmospheric wireless communications signals;

FIG. 5 is a functional block diagram of a communications network according to another embodiment of the invention in which directional antennas are used to form stratified subterranean communication links; and

FIG. 6 is a functional block diagram of a network device according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

As described in greater detail below, the invention enables a network to be expanded from the network core to the network edge without requiring deployment of wire line, optical fiber, or cable to the edge devices, through the utilization of underground wireless communications links.

Low frequency transmissions through the earth exhibit huge losses but are able to be transmitted at low power due to their relatively large wavelength. High frequency transmissions, by contrast, experience relatively low losses during transmission but to cover the same distance would have to be transmitted with higher power due to a smaller wavelength. To strike a balance between losses and power, it has been found that subterranean wireless transmissions according to the invention may take place at between 1 and 4 GHz or, more preferably, at around 2 GHz. While these disclosed ranges are the presently preferred ranges for envisioned signal transmissions, the invention is not limited to these particular enumerated ranges but rather extends to all suitable transmission ranges.

It is well known that relatively good transmission quality may be obtained in a medium where the ratio of the dielectric conductivity of the medium to the relative conductivity of the medium is much greater than 1, e.g., εᵣ/σᵣ>>1. At frequencies between 1 and 4 GHz, many subterranean conditions behave like a dielectric, which provide relatively low loss transmission mediums. Specifically, fresh water, polar ice caps, rocky ground, artic land, urban areas, and typical soils all have a εᵣ/σᵣ>>150. Mediums which can be considered as low loss dielectrics at 1-4 GHz are dry and moist soil. Accordingly, the best transmission mediums in order of performance are, assuming uniform media, (a) polar ice cap; (b) artic land; (c) urban areas; (d) rocky ground; (e) typical soil; and (f) fresh water.

Underground wireless networks can be deployed without incurring the high real estate costs associated with atmospheric wireless networks, because the footprint of an underground antenna is significantly lower than an aboveground antenna. Specifically, because an underground antenna can be placed at the bottom of a deep hole, such as a manhole or other hole bored into the ground by a conventional boring apparatus, underground networks do not need access to or space on a tall antenna tower. Accordingly, the amount of real estate required to support and deploy an underground network is minimal compared to that required to deploy an atmospheric wireless network. Moreover, the configuration and deployment of an underground network also enables currently allocated spectra to reused, since the wireless spectrum is not currently in use in the subterranean environment. This reuse of spectra reduces the cost associated with deploying the underground network.

Deploying the network devices underground has other benefits as well. For example, the underground environment has a relatively constant cool temperature and is sheltered from rain, sleet, snow, wind, and other sorts of extreme weather to which atmospheric based systems may be exposed. Additionally, the ground surrounding the subterranean network device provides natural electromagnetic (EM) containment. These factors enable the antenna and/or network device casing to be less robust than a conventional atmospheric based wireless antenna/network device, thus reducing the cost associated with producing the antennas and network devices.

One embodiment of a communications network according to an embodiment of the invention is illustrated in FIG. 1. As shown in FIG. 1, a base unit 10, deployed in a first geographic location 12, is connected via link 14 to a high speed data communications network 16. The link 14 may include one or more optical fibers, wires, focused lasers, point-to-point wireless, or other types of links configured to transmit data between the high speed data communications network 16 and the base unit 10. The high speed data communications network 16, in one embodiment, is connected to or forms a portion of the Internet.

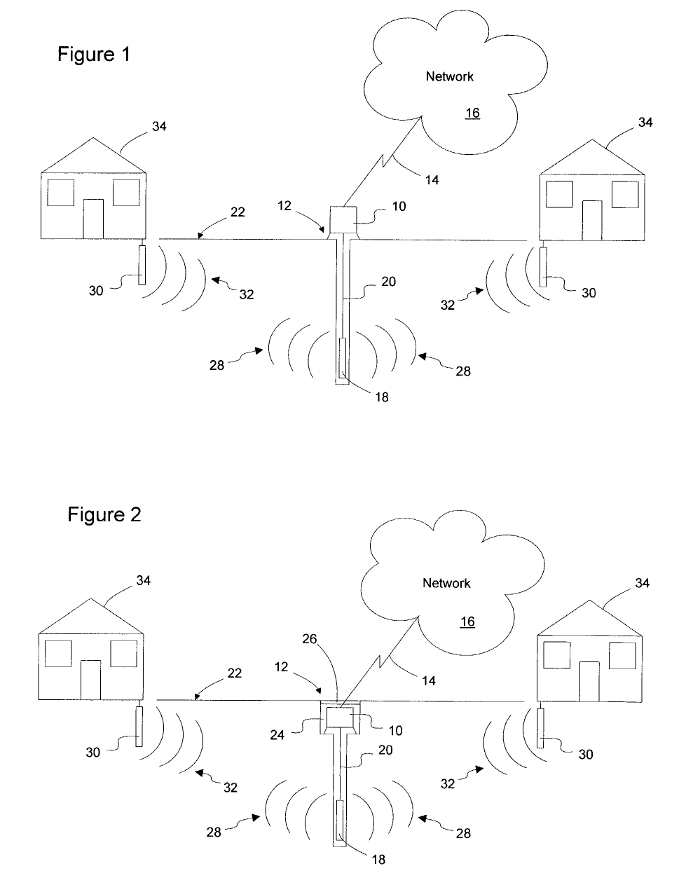

The base unit 10 is connected to an underground antenna 18 via a wire or optical fiber 20. In the embodiment illustrated in FIG. 1, the base unit 10 is designed to be deployed above the surface of the ground 22. In another embodiment, such as the embodiment illustrated in FIG. 2, the base unit 10 is designed to be deployed below the surface of the ground 22 in a hole 24 and protected from the atmosphere by a cover 26. Other permutations of the disposition of the base unit 10 with respect to the ground 22 are likewise possible.

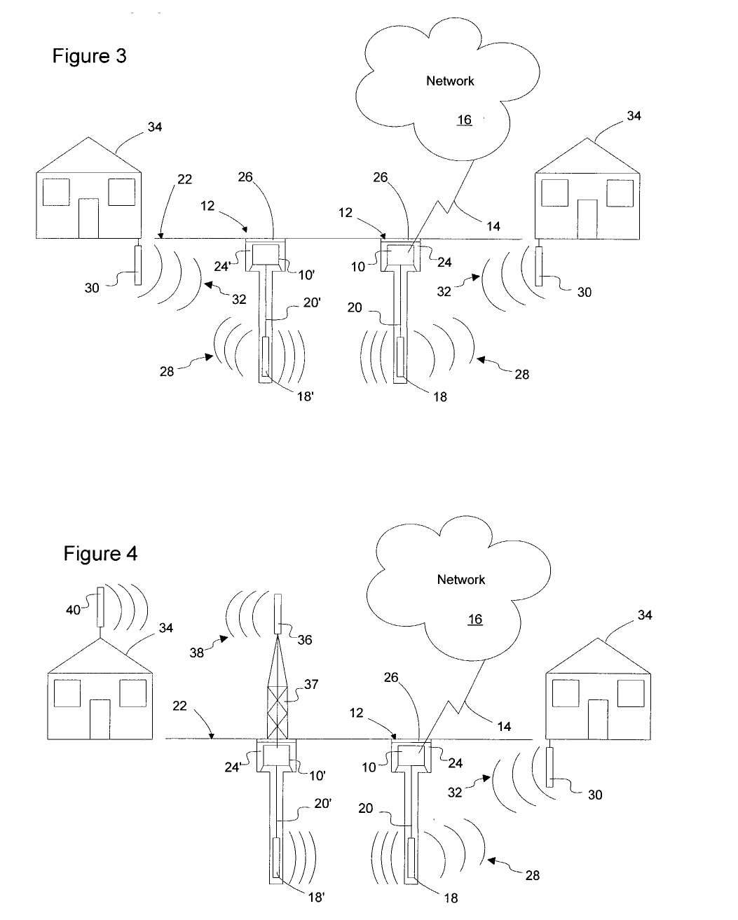

The base unit 10 is configured to transmit wireless signals 28 through the earth to remote units 30, and to receive wireless signals 32 from the remote units 30. The remote units 30 may be associated with individual receiving stations 34, for example at households or businesses desiring access to the high speed data communications network 16. Additionally, the remote units 30 may be associated with other transmitting stations, such as another base station (see FIG. 3) that is to be used as a repeater station (discussed in greater detail below). By forming a network in this manner, the signals may be transmitted from the high speed data communications network 16, through a high speed data communications link 14, broadcast underground via the antenna 18 of base unit 10, and received by the remote units 30. The high speed underground wireless communications link between the high bandwidth communication network and the end users thus eliminates the need to rewire existing networks to provide high speed data access to end users, while facilitating the addition or deletion of individual access nodes without significant expenditure of resources.

The remote unit 30 or the antenna of the remote unit 30 should be placed in the vicinity of the foundation of a user's house, preferably below pipe level to avoid any potential interference between the signals and the pipes in the house. Preferably, the antenna should be placed at a relatively low depth in the earth to provide an unobstructed path between the remote antenna and the remote access unit. In one embodiment, the antenna is designed to fit down into a remote user's well or other hole dug on the user's property. Typical water wells are 50 to several hundred feet deep. Placing the antenna down the existing hole enables the antenna of the remote unit 30 to be simply and cost effectively deployed without requiring the remote user to have a new hole bored to accommodate the remote underground antenna.

The base unit 10, according to one embodiment of the invention, utilizes non-linear amplifiers to achieve high efficiency signal amplification. This enables the network device to have low DC battery drain, reduced heat sink requirements, lower junction temperatures, and lower input power, all of which contribute to increased reliability and reduced operating costs. In one embodiment, class D or F amplifiers having an efficiency rating of 50% or above are utilized, although any suitable high efficiency amplifier may be used. To eliminate or minimize attenuation due to ground non-uniformity, reflection compensating systems can be employed to equalize the incoming signals or to predictor the transmitted signals.

Another embodiment of the invention is illustrated in FIG. 3. As shown in FIG. 3, at times the signal strength of the communications signals 28, 32, being transmitted may attenuate too quickly or may need to travel too far to enable a sufficiently robust communications link to be formed. In this instance, additional base units 10′ may be utilized to intercept signals and relay the signals onward to other remote units. In the embodiment illustrated in FIG. 3, a high speed communications link 14 is established between the high speed communications network 16 and base unit 10. The base unit 10 emits underground signals via antenna 18 which are received by underground antenna 18′. The signals are amplified by base unit 10′ and rebroadcast to remote unit 30. Note that in this embodiment the base unit 10′ is not connected to the high speed data network 16 other than through base unit 10. Signals may travel in the reverse order as well. Enabling base units to be chained together in this fashion enables the underground communications link to be extended through or routed around challenging geographic or geologic formations that otherwise could hinder deployment of underground communications links to particular geographic areas. Although a single repeater station 10′ is shown in FIG. 3, multiple repeater stations may be utilized and the invention is not limited to utilizing a single repeater station.

Another embodiment of the invention is illustrated in FIG. 4. In this embodiment, underground wireless communications links are utilized to interconnect a base unit 10 with pico cells configured to transmit atmospheric wireless communications signals. Specifically, as shown in FIG. 4, a base unit 10 is configured, as in FIG. 1, to broadcast subterranean wireless signals. These wireless signals are received by an underground antenna 18′ associated with base unit 10′. Optionally, the underground communications signals 28 may also be broadcast from base unit 10 to one or more remote units 30.

A pico cell 36 on top of a tower 37 is connected to the base unit 10′ and configured to transmit atmospheric wireless signals 38 over a short distance to one or more atmospheric receiving antennas 40. A network of this nature may be particularly useful for implementing a pico cell wireless network in which the individual cells are designed to be deployed relatively low to the ground, e.g. on top of a building or lamp post, and to have a relatively small range of coverage (e.g. one to five square miles).

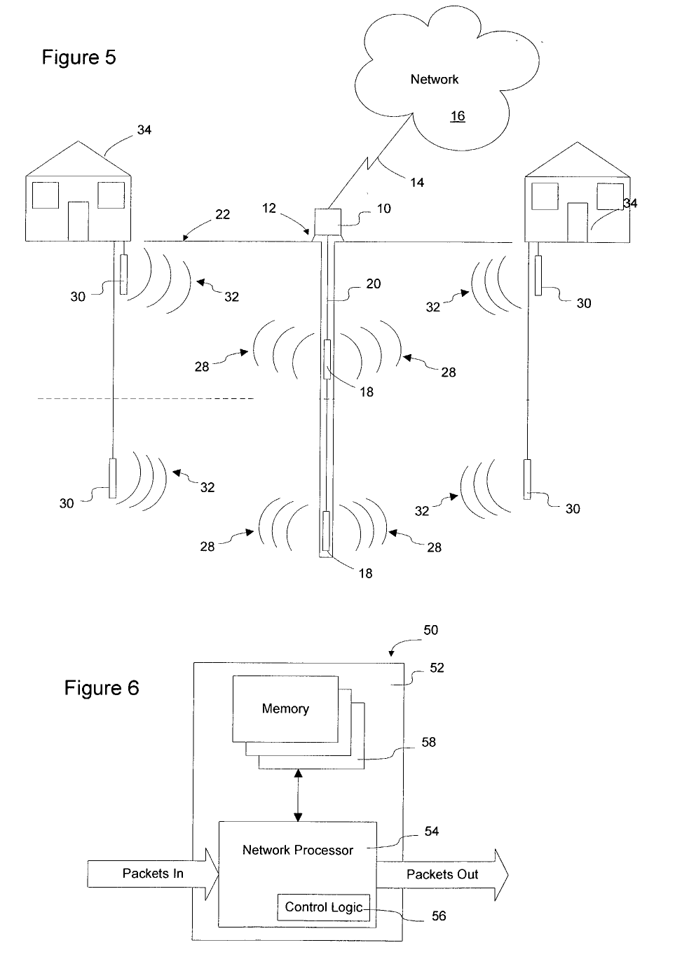

According to another embodiment, as illustrated in FIG. 5, directional antennas are used to provide stratified subterranean communication channels. By utilizing directional antennas disposed at different depths within the ground, multiple tiers of subterranean communication may be formed to enable greater numbers of signals to be propagated through a given geographical area. The efficiency of the directionality of the antennas utilized in this embodiment may be increased by selecting the antenna depth to coincide with transmission favorable geologic formations.

Specifically, as illustrated in FIG. 5, a base unit 10 has a first antenna 18 deployed at a first depth and a second antenna 18′ deployed at a second depth. A remote unit 30 has a first antenna 30 deployed at a first depth and a second antenna 30′ deployed at a second depth. These two depths may coincide with the first and second depths of the antennas 18, 18′, or may be selected to coincide with particular geological formations.

Multiple tiers of subterranean communication links may provide a number of benefits. For example, it may be possible to utilize one communications layer for transmissions from the base unit 10 to the remote unit 30, and the other communications layer for transmissions from the remote unit 30 to the base unit 10. Alternatively, the multiple layers can carry the same signals to reduce noise, reduce the data error rate associated with the underground transmission, and to enable enhanced signal integrity checking.

The transmitting stations (base unit 10 and remote unit 30) in this embodiment may use directional antennas to confine the signals within a given ranges of depths, or may take advantage of natural geographical formations to separate the subterranean transmission layers. Any conventional directional antenna may be used to directionally transmit the subterranean signals, although it may prove to be advantageous to utilize directional antennas optimized for subterranean wireless signal transmission.

Although two antennas 18 are deployed at two depths in FIG. 5, the invention is not limited to only two depths but rather extends to any number of antennas deployed at any number of available depths. Likewise, while both antennas are connected to the same base unit 10 in FIG. 5, additional base units at the same location 12 could be utilized, each such base unit 10 being configured to control one of the antennas. Accordingly, the invention extends to all such embodiments and is not limited to the particular arrangement illustrated in FIG. 5.

One example of a network device that may be used in connection with the various embodiments of this invention is illustrated in FIG. 6. As shown in FIG. 6, a network device 50 configured to receive packets and output packets includes, in this embodiment, a network processor 52 with control logic 54 configured to implement the functions described in greater detail above. A memory 56, internal to the network device as shown, or external to the network device, may be provided to store computer instructions to enable the network device to perform the functions ascribed to it herein. A physical or virtual network management interface 58 may be provided to enable the network manager to interact with the network device.

The control logic 54 of the network device may be implemented as a set of program instructions that are stored in a computer readable memory 56 and executed on a microprocessor, such as network processor 52. However, it will be apparent to a skilled artisan that all logic described herein can be embodied using discrete components, integrated circuitry, programmable logic used in conjunction with a programmable logic device such as a Field Programmable Gate Array (FPGA) or microprocessor, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

While various applications of an underground wireless network have been described herein, the invention is not limited to the several discussed applications, but extends more generally to other applications where one or more subterranean wireless links may be used to augment one or more communications networks.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of providing communications services, comprising:
interconnecting a data link from a high bandwidth network to a base unit; and
transmitting subterranean wireless signals from the base unit to a second unit.

2. The method of claim 1, wherein the subterranean wireless signals are first transmitted over the data link from the high bandwidth network to the base unit, and are then transmitted from the base unit to the second unit.

3. The method of claim 2, wherein the subterranean wireless signals are in a frequency range between 1 and 4 gigahertz.

4. The method of claim 2, wherein the high bandwidth network forms a part of the Internet.

5. The method of claim 2, wherein the data link is a high bandwidth data link.

6. The method of claim 1, wherein transmitting subterranean wireless signals employs at least one subterranean directional antenna.

7. The method of claim 1, wherein the second unit is an end user, and wherein the method further comprises the steps of:
receiving, by the end user, the subterranean wireless signals via an underground antenna; and
transmitting, by the end user, subterranean signals from the end user to the base unit.

8. The method of claim 1, wherein the second unit is a pico cell network device configured to emit atmospheric wireless network signals.

9. The method of claim 1, wherein the second unit is a repeater base unit.

10. An apparatus for extending a high bandwidth communications network, comprising:
a base unit configured to receive high bandwidth communications signals from the high bandwidth communications network; and
a subterranean antenna connected to said base unit and configured to broadcast subterranean wireless signals.

11. The apparatus of claim 10, wherein the subterranean wireless signals are first transmitted over a data link from the high bandwidth network to the base unit, and are then transmitted from the base unit to the second unit.

12. The apparatus of claim 11, wherein the subterranean wireless signals are in a frequency range between 1 and 4 gigahertz.

13. The apparatus of claim 11, wherein the high bandwidth network forms a part of the Internet.

14. The apparatus of claim 10, wherein the subterranean antenna comprises a first subterranean directional antenna and a second subterranean directional antenna.

15. The apparatus of claim 10, wherein the first subterranean directional antenna is configured to transmit subterranean wireless signals at a first depth, and wherein the second subterranean directional antenna is configured to transmit subterranean wireless signals at a second depth.

16. A network, comprising:
a base unit configured to receive signals from a high bandwidth communications link and to transmit said high frequency high bandwidth signals under ground as high frequency high bandwidth underground data signals; and
a plurality of remote units, each said remote unit having the ability to receive the high frequency high bandwidth underground data signals.

17. The network of claim 16, further comprising:
a repeater unit configured to intercept the high frequency high bandwidth underground data signals, amplify the high frequency high bandwidth underground data signals, and transmit the amplified high frequency high bandwidth underground data signals underground as amplified high frequency high bandwidth underground data signals.

18. The network of claim 16, further comprising:
a pico cell unit configured to intercept the high frequency high bandwidth underground data signals, amplify the high frequency high bandwidth underground data signals, and transmit the amplified high frequency high bandwidth underground data signals aboveground as high frequency high bandwidth atmospheric data signals.
